(19) United States
(12) Patent Application Publication
(10) Pub. No.: US 2021/0208808 A1
(43) Pub. Date: Jul. 8, 2021

(54) Host Supported Partitions in Storage Device

(71) Applicant: WESTERN DIGITAL TECHNOLOGIES, INC., San Jose, CA (US)

(72) Inventors: Eshaan Gupta, Bangalore (IN); Dharmaraju Marenahally Krishna, Bangalore (IN); Abhinand Amarnath, Bangalore (IN); Ashish Kumar, Kondapur (IN)

(21) Appl. No.: 16/749,408

(22) Filed: Jan. 22, 2020

Related U.S. Application Data
(60) Provisional application No. 62/957,078, filed on Jan. 3, 2020.

(51) Int. Cl. G06F 3/06; G06F 21/78; G06F 21/34; G06F 21/46

(52) U.S. Cl. CPC G06F 3/0644; G06F 3/0653; G06F 3/0659; G06F 3/0652; G06F 21/46; G06F 3/0622; G06F 3/0673; G06F 21/78; G06F 21/34; G06F 3/0604

(57) ABSTRACT

Aspects of a storage device are provided which allow for partitioning of memory based on partition commands received from a host device. The storage device includes a memory configured to store data, and a controller configured to partition the memory into multiple partitions based on a partition command received from the host device. The controller is further configured to switch from a first partition to a second partition in response to a partition switching command received from the host device, and the controller may execute a command received from the host device on data associated with the second partition. When the controller receives the command from the host device associated with data including a logical address, the controller may update the logical address based on the second partition and execute the command based on the updated logical address.

### CROSS REFERENCE TO RELATED APPLICATIONS

This application claims the benefit of U.S. Provisional Application No. 62/957,078, entitled “Host Supported Partitions in Storage Device” and filed on Jan. 3, 2020, which is expressly incorporated by reference herein in its entirety.

### BACKGROUND

### Field

This disclosure is generally related to electronic devices and more particularly to storage devices.

### Background

Storage devices enable users to store and retrieve data. Examples of storage devices include non-volatile memory devices. A non-volatile memory generally retains data after a power cycle. An example of a non-volatile memory is a flash memory, which may include array(s) of NAND cells on one or more dies. Flash memory may be found in solid-state devices (SSDs), Secure Digital (SD) cards, and the like.

A flash storage device may store control information associated with data. For example, a flash storage device may maintain control tables that include a mapping of logical addresses to physical addresses. This control tables are used to track the physical location of logical sectors, or blocks, in the flash memory. The control tables are stored in the non-volatile memory to enable access to the stored data after a power cycle.

A host device generally accesses the flash storage device using a File Allocation Table (FAT). Each version of FAT (e.g. FAT12, FAT16, FAT32) is limited in the amount of data it can address, which in turn limits the flash storage devices that the host device can support. For example, a host device supporting FAT32 (e.g. 32-bit addressing) may only be able to support a flash storage device memory capacity of 4 GB, and mobile host devices typically have a similar maximum limit on storage capacity for external memory. As a result, the host device may be limited in the flash storage devices it can access.

### SUMMARY

One aspect of a storage device is disclosed herein. The storage device includes a memory configured to store data, and a controller configured to partition the memory into multiple partitions for a host device based on a partition command received from the host device. The controller is configured to switch from a first one of the partitions to a second one of the partitions in response to a partition switching command received from the host device. The controller is also configured to execute a command received from the host device on data associated with the second one of the partitions.

Another aspect of a storage device is disclosed herein. The storage device includes a memory configured to store data, and a controller configured to partition the memory into multiple partitions based on a partition command received from a host device. The controller is configured to receive a command from the host device associated with data including a logical address, to update the logical address based on a selected one of the partitions for the host device, and to execute the command on data associated with the selected one of the partitions based on the updated logical address.

A further aspect of a storage device is disclosed herein. The storage device includes a memory configured to store data, and a controller configured to partition the memory into multiple partitions for a host device based on a partition command received from the host device. The controller is configured to select one of the partitions based on user credentials received from the host device. The controller is also configured to execute a command received from the host device on data associated with the selected one of the partitions.

It is understood that other aspects of the storage device will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of the present invention will now be presented in the detailed description by way of example, and not by way of limitation, with reference to the accompanying drawings, wherein:

FIG. 1 is a block diagram illustrating an exemplary embodiment of a storage device in communication with a host device.

FIG. 2 is a conceptual diagram illustrating an example of a logical-to-physical mapping table in a non-volatile memory of the storage device of FIG. 1.

FIG. 3 is a conceptual diagram illustrating an example of a partitioned memory of the storage device of FIG. 1.

FIG. 4 is a flow chart illustrating an exemplary method for initializing the storage device of FIG. 1 with multiple partitions in memory.

FIG. 5 is a flow chart illustrating an exemplary method for switching between partitions in the storage device of FIG. 1.

FIG. 6 is a flow chart illustrating an exemplary method for executing a command from a host device in a partition of the storage device of FIG. 1.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The words “exemplary” and “example” are used herein to mean serving as an example, instance, or illustration. Any exemplary embodiment described herein as “exemplary” is not necessarily to be construed as preferred or advantageous over other exemplary embodiments. Likewise, the term “exemplary embodiment” of an apparatus, method or article of manufacture does not require that all exemplary embodiments of the invention include the described components, structure, features, functionality, processes, advantages, benefits, or modes of operation.

In the following detailed description, various aspects of a storage device in communication with a host device will be presented. These aspects are well suited for flash storage devices, such as SSDs and SD cards. However, those skilled in the art will realize that these aspects may be extended to all types of storage devices capable of storing data. Accordingly, any reference to a specific apparatus or method is intended only to illustrate the various aspects of the present invention, with the understanding that such aspects may have a wide range of applications without departing from the spirit and scope of the present disclosure.

Typically, a host device is limited in the storage devices it can support. For example, a host device operating under a FAT32 file system may only be able to support flash storage devices with a maximum capacity of 4 GB. However, given recent advances in memory technology, flash storage devices may have much larger die capacity (e.g. 512 GB or larger), although with less memory endurance (e.g. 1K read/write cycles for quad level cells (QLCs)). While upgrading the firmware of the host device may possibly allow for support of larger storage capacities, such host device upgrades are not always feasible. For instance, many mobile devices such as smartphones and tablets which are used for information and entertainment purposes may be limited in the amount of external memory they can support based on their file systems (e.g. no more than 32 GB).

To allow current storage devices to adapt to the supported capacity of a host device, the present disclosure allows a controller of the storage device to partition its memory in response to a partition command of the host device. The host device may send a partition command to the storage device, including a maximum storage capacity of the host device or a selected storage capacity for the host device. For instance, a host device supporting only 32 GB may send a partition command to a 512 GB storage device requesting a partition equal to the maximum storage capacity of the host device (e.g. 32 GB) or a selected storage capacity for the host device (e.g. 8 GB, 16 GB, etc.) After receiving the partition command, the storage device may internally partition its memory and display only one of those partitions to the host device. For instance, the storage device may partition its 512 GB memory into sixteen 32 GB partitions and allow the host device to access only one of those 32 GB partitions at a time. The host device may dynamically switch to any of the available partitions, one at a time, and read and write data throughout the various partitions provided by the storage device.

As a result, the present disclosure adapts to the supported capacity of the host device by allowing for partitioning of memory to the host device's needs. For example, a host device which only supports a 32 GB memory capacity can access a 512 GB storage device (or any size storage device) using 32 GB or lower partitions, without being required to upgrade firmware to support the storage device's maximum memory capacity (or to be completely replaced if such upgrade is not feasible). Moreover, by being able to switch between the different partitions, the host device may be able to virtually access the maximum storage provided by the storage device. For example, the host device may be able to access any of the memory of the 512 GB storage device by switching between all the 32 GB partitions.

Additionally, host devices (including the flash memory) may be shared by multiple users. For example, one user may pass their tablet to another user, and both users may use the same flash memory connected to the tablet. As a result, the data of one user may be lost from possible overwriting of the data by another user. To minimize data loss from sharing by multiple users, the present disclosure may allow the storage device to partition the memory into a separate partition for each user. For example, when one of four users of a host device sends the partition command to the storage device, the storage device may create four partitions respectively associated with each user and only display one of the partitions to each respective user. Each partition may also be associated with the respective user's credentials, such as a password. As a result, the present disclosure may also allow users to access only their respective partitions when they log in using their credentials to the host device, preventing comingling or overwriting of different users' data and possible data loss.

Furthermore, the present disclosure may virtually provide a higher endurance storage device, although with lower memory capacity due to the partitioning. For example, in a storage device of single level cells (SLCs) and QLCs, the controller of the storage device may configure a set of SLC blocks as one partition and the remaining QLC blocks as another partition(s). Since SLCs typically have larger read/write cycles than QLCs (e.g. 10k versus 1k), higher endurance or performance may be achieved for read or write commands executed on the SLC partition(s).

Additionally, while the storage device may select a partition based on the partition command of the host device or based on user credentials as described above, the storage device may also select a partition based on performance. For instance, the controller of the storage device may select a higher performance (e.g. SLCs) or lower performance (e.g. QLCs) partition for a host device based on data associated with the host command to be executed. For example, if the controller receives a read or write command for critical information (e.g. file system information, etc.), the controller may select the higher performance partition for access, while if the controller receives a read or write command for less critical information (e.g. regular data), the lower performance partition may be selected.

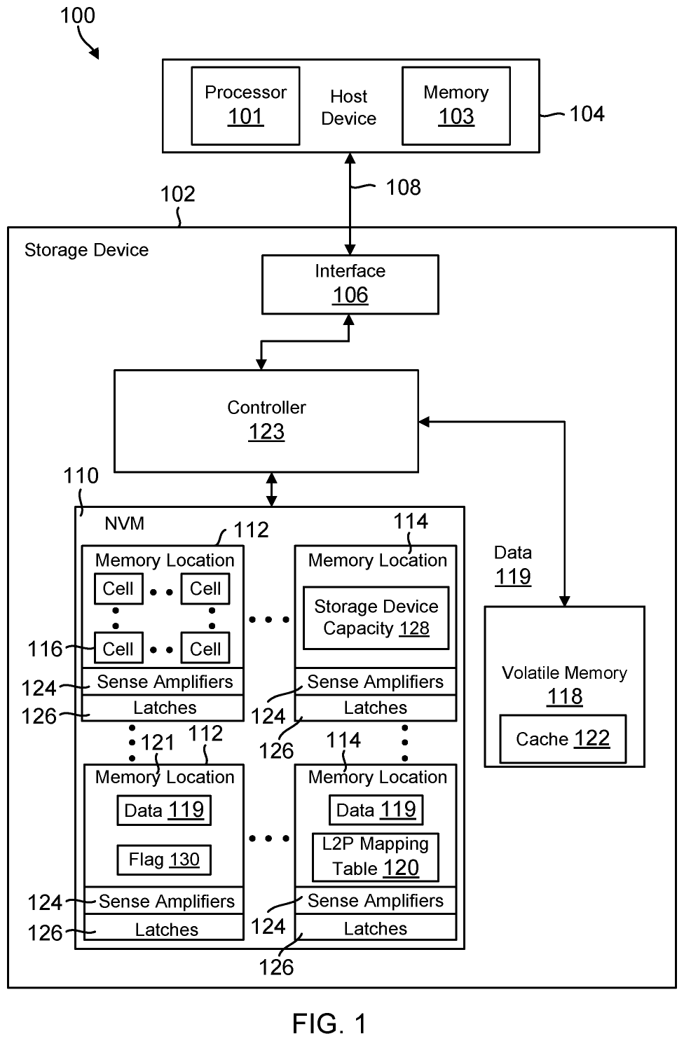

FIG. 1 shows an exemplary block diagram 100 of a storage device 102 which communicates with a host device 104 (also “host”) according to an exemplary embodiment. The host 104 and the storage device 102 may form a system, such as a computer system (e.g., server, desktop, mobile/laptop, tablet, smartphone, etc.). The components of FIG. 1 may or may not be physically co-located. In this regard, the host 104 may be located remotely from storage device 102. Although FIG. 1 illustrates that the host 104 is shown separate from the storage device 102, the host 104 in other embodiments may be integrated into the storage device 102, in whole or in part. Alternatively, the host 104 may be distributed across multiple remote entities, in its entirety, or alternatively with some functionality in the storage device 102.

Those of ordinary skill in the art will appreciate that other exemplary embodiments can include more or less than those elements shown in FIG. 1 and that the disclosed processes can be implemented in other environments. For example, other exemplary embodiments can include a different number of hosts communicating with the storage device 102, or multiple storage devices 102 communicating with the host(s).

The host device 104 may store data to, and/or retrieve data from, the storage device 102. The host device 104 may include any computing device, including, for example, a computer server, a network attached storage (NAS) unit, a desktop computer, a notebook (e.g., laptop) computer, a tablet computer, a mobile computing device such as a smartphone, a television, a camera, a display device, a digital media player, a video gaming console, a video streaming device, or the like. The host device 104 may include at least one processor 101 and a host memory 103. The at least one processor 101 may include any form of hardware capable of processing data and may include a general purpose processing unit (such as a central processing unit (CPU)), dedicated hardware (such as an application specific integrated circuit (ASIC)), digital signal processor (DSP), configurable hardware (such as a field programmable gate array (FPGA)), or any other form of processing unit configured by way of software instructions, firmware, or the like. The host memory 103 may be used by the host device 104 to store data or instructions processed by the host or data received from the storage device 102. In some examples, the host memory 103 may include non-volatile memory, such as magnetic memory devices, optical memory devices, holographic memory devices, flash memory devices (e.g., NAND or NOR), phase-change memory (PCM) devices, resistive random-access memory (ReRAM) devices, magnetoresistive random-access memory (MRAM) devices, ferroelectric random-access memory (F-RAM), and any other type of non-volatile memory devices. In other examples, the host memory 103 may include volatile memory, such as random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like). The host memory 103 may also include both non-volatile memory and volatile memory, whether integrated together or as discrete units.

The host interface 106 is configured to interface the storage device 102 with the host 104 via a bus/network 108, and may interface using, for example, Ethernet or WiFi, or a bus standard such as Serial Advanced Technology Attachment (SATA), PCI express (PCIe), Small Computer System Interface (SCSI), or Serial Attached SCSI (SAS), among other possible candidates. Alternatively, the host interface 106 may be wireless, and may interface the storage device 102 with the host 104 using, for example, cellular communication (e.g. 5G NR, 4G LTE, 3G, 2G, GSM/UMTS, CDMA One/CDMA2000, etc.), wireless distribution methods through access points (e.g. IEEE 802.11, WiFi, HiperLAN, etc.), Infra Red (IR), Bluetooth, Zigbee, or other Wireless Wide Area Network (WWAN), Wireless Local Area Network (WLAN), Wireless Personal Area Network (WPAN) technology, or comparable wide area, local area, and personal area technologies.

As shown in the exemplary embodiment of FIG. 1, the storage device 102 includes non-volatile memory (NVM) 110 for non-volatilely storing data received from the host 104. The NVM 110 can include, for example, flash integrated circuits, NAND memory (e.g., single-level cell (SLC) memory, multi-level cell (MLC) memory, triple-level cell (TLC) memory, quad-level cell (QLC) memory, penta-level cell (PLC) memory, or any combination thereof), or NOR memory. The NVM 110 may include a plurality of memory locations 112 which may store system data for operating the storage device 102 or user data received from the host for storage in the storage device 102. For example, the NVM may have a cross-point architecture including a 2-D NAND array of memory locations 112 having n rows and m columns, where m and n are predefined according to the size of the NVM. In the illustrated exemplary embodiment of FIG. 1, each memory location 112 may be a block 114 including multiple cells 116. The cells 116 may be SLCs, MLCs, TLCs, QLCs, and/or PLCs, for example. Other examples of memory locations 112 are possible; for instance, each memory location may be a die containing multiple blocks. Moreover, each memory location may include one or more blocks in a 3-D NAND array. Moreover, the illustrated memory locations 112 may be logical blocks which are mapped to one or more physical blocks.

The storage device 102 also includes a volatile memory 118 that can, for example, include a Dynamic Random Access Memory (DRAM) or a Static Random Access Memory (SRAM). Data stored in volatile memory 118 can include data read from the NVM 110 or data to be written to the NVM 110. In this regard, the volatile memory 118 can include a write buffer and a read buffer for temporarily storing data. While FIG. 1 illustrates the volatile memory 118 as being remote from a controller 123 of the storage device 102, the volatile memory 118 may be integrated into the controller 123.

The memory (e.g. NVM 110) is configured to store data 119 received from the host device 104. The data 119 may be stored in the cells 116 of any of the memory locations 112. As an example, FIG. 1 illustrates data 119 being stored in different memory locations 112, although the data may be stored in the same memory location. In another example, the memory locations 112 may be different dies, and the data may be stored in one or more of the different dies.

Each of the data 119 may be associated with a logical address. For example, the NVM 110 may store a logical-to-physical (L2P) mapping table 120 for the storage device 102 associating each data 119 with a logical address. The L2P mapping table 120 stores the mapping of logical addresses specified for data written from the host 104 to physical addresses in the NVM 110 indicating the location(s) where each of the data is stored. This mapping may be performed by the controller 123 of the storage device. The L2P mapping table may be a table or other data structure which includes an identifier such as a logical block address (LBA) associated with each memory location 112 in the NVM where data is stored. While FIG. 1 illustrates a single L2P mapping table 120 stored in one of the memory locations 112 of NVM to avoid unduly obscuring the concepts of FIG. 1, the L2P mapping table 120 in fact may include multiple tables stored in one or more memory locations of NVM.

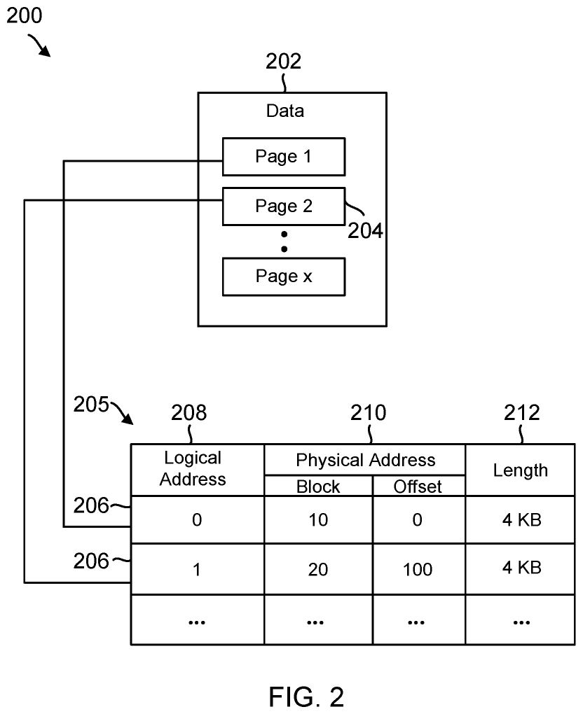

FIG. 2 is a conceptual diagram 200 of an example of an L2P mapping table 205 illustrating the mapping of data 202 received from a host device to logical addresses and physical addresses in the NVM 110 of FIG. 1. The data 202 may correspond to the data 119 in FIG. 1, while the L2P mapping table 205 may correspond to the L2P mapping table 120 in FIG. 1. In one exemplary embodiment, the data 202 may be stored in one or more pages 204, e.g., pages 1 to x, where x is the total number of pages of data being written to the NVM 110. Each page 204 may be associated with one or more entries 206 of the L2P mapping table 205 identifying a logical block address (LBA) 208, a physical address 210 associated with the data written to the NVM, and a length 212 of the data. LBA 208 may be a logical address specified in a write command for the data received from the host device. Physical address 210 may indicate the block and the offset at which the data associated with LBA 208 is physically written. Length 212 may indicate a size of the written data (e.g. 4 KB or some other size).

Referring back to FIG. 1, the volatile memory 118 also stores a cache 122 for the storage device 102. The cache 122 includes entries showing the mapping of logical addresses specified for data requested by the host 104 to physical addresses in NVM 110 indicating the location(s) where the data is stored. This mapping may be performed by the controller 123. When the controller 123 receives a read command or a write command for data 119, the controller checks the cache 122 for the logical-to-physical mapping of each data. If a mapping is not present (e.g. it is the first request for the data), the controller accesses the L2P mapping table 120 and stores the mapping in the cache 122. When the controller 123 executes the read command or write command, the controller accesses the mapping from the cache and reads the data from or writes the data to the NVM 110 at the specified physical address. The cache may be stored in the form of a table or other data structure which includes a logical address associated with each memory location 112 in NVM where data is being read.

The NVM 110 includes sense amplifiers 124 and data latches 126 connected to each memory location 112. For example, the memory location 112 may be a block including cells 116 on multiple bit lines, and the NVM 110 may include a sense amplifier 124 on each bit line. Moreover, one or more data latches 126 may be connected to the bit lines and/or sense amplifiers. The data latches may be, for example, shift registers. When data is read from the cells 116 of the memory location 112, the sense amplifiers 124 sense the data by amplifying the voltages on the bit lines to a logic level (e.g. readable as a ‘0’ or a ‘1’), and the sensed data is stored in the data latches 126. The data is then transferred from the data latches 126 to the controller 123, after which the data is stored in the volatile memory 118 until it is transferred to the host device 104. When data is written to the cells 116 of the memory location 112, the controller 123 stores the programmed data in the data latches 126, and the data is subsequently transferred from the data latches 126 to the cells 116.

The storage device 102 includes a controller 123 which includes circuitry such as one or more processors for executing instructions and can include a microcontroller, a Digital Signal Processor (DSP), an Application-Specific Integrated Circuit (ASIC), a Field Programmable Gate Array (FPGA), hard-wired logic, analog circuitry and/or a combination thereof.

The controller 123 is configured to receive data transferred from one or more of the cells 116 of the various memory locations 112 in response to a read command. For example, the controller 123 may read the data 119 by activating the sense amplifiers 124 to sense the data from cells 116 into data latches 126, and the controller 123 may receive the data from the data latches 126. The controller 123 is also configured to program data into one or more of the cells 116 in response to a write command. For example, the controller 123 may write the data 119 by sending data to the data latches 126 to be programmed into the cells 116. The controller 123 is further configured to access the L2P mapping table 120 in the NVM 110 when reading or writing data to the cells 116. For example, the controller 123 may receive logical-to-physical address mappings from the NVM 110 in response to read or write commands from the host device 104, identify the physical addresses mapped to the logical addresses identified in the commands, and access or store data in the cells 116 located at the mapped physical addresses.

The controller 123 may be further configured to access the memory locations 112 in parallel. For example the memory locations 112 may be blocks 114 stored on different dies of the NVM 110, and each die may be connected to the controller 123 by its own data bus. The controller may read or write data to the cells 116 on the different dies simultaneously over the multiple data buses. Additionally, the controller 123 may be configured to refrain from accessing the memory locations 112 in parallel, and may instead access the memory locations 112 serially. For example, the controller may determine to read or write data to the cells 116 of a memory location 112 in sequence rather than simultaneously over the multiple data buses.

The controller 123 and its components may be implemented with embedded software that performs the various functions of the controller described throughout this disclosure. Alternatively, software for implementing each of the aforementioned functions and components may be stored in the NVM 110 or in a memory external to the storage device 102 or host device 104, and may be accessed by the controller 123 for execution by the one or more processors of the controller 123. Alternatively, the functions and components of the controller may be implemented with hardware in the controller 123, or may be implemented using a combination of the aforementioned hardware and software.

In operation, the host device 104 stores data in the storage device 102 by sending a write command to the storage device 102 specifying one or more logical addresses (e.g., LBAs) as well as a length of the data to be written. The interface element 106 receives the write command, and the controller allocates a memory location 112 in the NVM 110 of storage device 102 for storing the data. The controller 123 stores the L2P mapping in the NVM (and the cache 122) to map a logical address associated with the data to the physical address of the memory location 112 allocated for the data. The controller also stores the length of the L2P mapped data. The controller 123 then stores the data in the memory location 112 by sending it to one or more data latches 126 connected to the allocated memory location, from which the data is programmed to the cells 116.

The host 104 may retrieve data from the storage device 102 by sending a read command specifying one or more logical addresses associated with the data to be retrieved from the storage device 102, as well as a length of the data to be read. The interface 106 receives the read command, and the controller 123 accesses the L2P mapping in the cache 122 or otherwise the NVM to translate the logical addresses specified in the read command to the physical addresses indicating the location of the data. The controller 123 then reads the requested data from the memory location 112 specified by the physical addresses by sensing the data using the sense amplifiers 124 and storing them in data latches 126 until the read data is returned to the host 104 via the host interface 106.

As described above, the host device 104 may read and write data 119 to the storage device 102 when the storage device is connected to the host device. However, the aforementioned process assumes the host device can support the memory capacity of the storage device. If the storage device's memory exceeds the capacity of the host device (e.g. due to FAT limitations), the host device may not be able to successfully access the storage device. Therefore, when the storage device 102 is connected to the host device 104 to be initialized, the host device requests a storage device capacity 128 from the storage device to determine whether the host device can support the storage device. The storage device capacity 128 may be stored in an internal register (e.g. a Card-Specific Data (CSD) register) of the NVM 110. During initialization, if the host device determines that the storage device capacity is not supported (e.g. the storage device capacity 128 is greater than the supported capacity of the host device), the host device may send a partition command to the storage device to partition itself based on the supported capacity of the host device. The controller 123 of the storage device may then partition the NVM 110 into multiple partitions for the host device 104 based on the partition command.

For example, if the storage device is a 512 GB universal SD (uSD) card and the host device supports at most 32 GB, the host device may request the storage device to create at most sixteen 32 GB partitions. The host device may request the partitioning, for instance, by sending a SD protocols command to the storage device (e.g. a vendor-specific command with predefined arguments or parameters, discussed below). After the storage device creates the partitions, the storage device updates storage device capacity 128 (e.g. the CSD) and returns the updated storage device capacity to the host device. For instance, assuming the CSD was originally 512 GB, the storage device may update the CSD to the size of the partition to be used by the host device (e.g. 32 GB), and report that indication to the host device. By changing the CSD from the total size of the storage device to the requested partition size and reporting that capacity to the host device, the storage device effectively causes the firmware of the host device to assume the storage device supports the host device's capacity, thereby allowing interfacing between the storage device and host device to successfully occur.

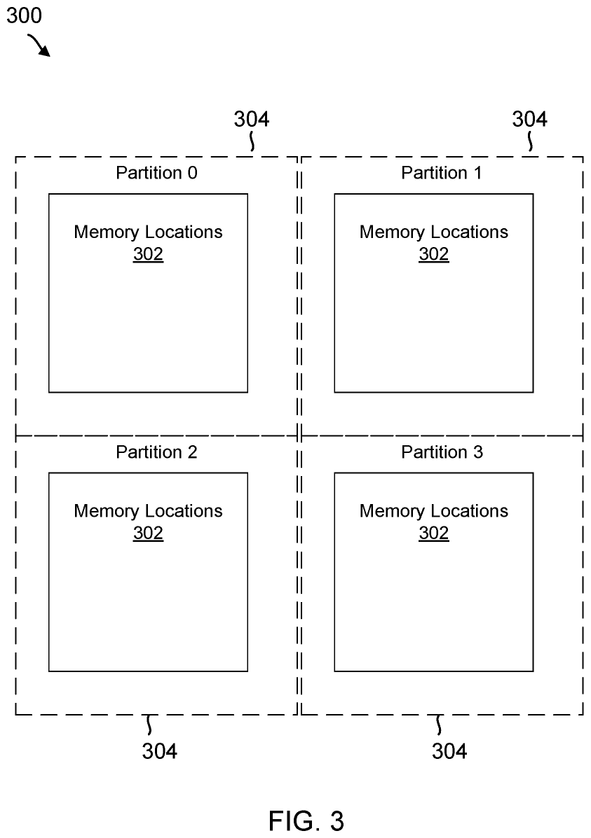

FIG. 3 illustrates an example diagram of memory locations 302 divided into multiple partitions 304. Memory locations 302 may correspond to one or more memory locations 112 in FIG. 1. In the example of FIG. 3, the storage device (e.g. storage device 102) has created four equally sized partitions 304 in response to the partition command from the host device (e.g. host device 104). However, the partitioning is not so limited; any number or size of partitions may be created, and the partitions may be equal or unequal in size. For instance, the host device may send a partition command to the storage device to create two 8 GB partitions, one 16 GB partition, and one 32 GB partition, and the storage device may divide the memory locations between the four partitions accordingly.

Each partition may correspond to a number of associated LBAs based on the size of the partitions. For instance, in the example of FIG. 3 where the NVM 110 is divided into four equally sized partitions 304 in response to the partition command, the first partition (0) may include memory locations corresponding to the first 25% of all LBAs, the second partition (1) may include memory locations corresponding to the second 25% of all LBAs, the third partition (2) may include memory locations corresponding to the third 25% of all LBAs, and the fourth partition (3) may include memory locations corresponding to the last 25% of all LBAs. Similarly in another example, if the partition command requests the storage device to divide the memory locations 112 into two 8 GB partitions, one 16 GB partition, and one 32 GB partition, the controller may allocate the partitions such that partitions (0) and (1) each include memory locations corresponding to one eighth of the LBAs, partition (2) includes memory locations corresponding to one fourth of the LBAs, and partition (3) includes memory locations corresponding to one half of the LBAs.

When the controller 123 of the storage device receives the partition command from the host device indicating the number and size of partitions, the controller may divide the LBAs accordingly (e.g. based on the number and size of partitions as described above) and select a default partition (e.g. the first partition (0) or another partition) for the host device. When the host device subsequently sends read, write, or erase commands with logical addresses to the storage device, the storage device may route the command to the associated logical address of the selected partition (e.g. by updating the logical address based on the divided LBAs, and as further described below). In this way, misreading or overwriting of data in identical LBAs of other partitions may be avoided.

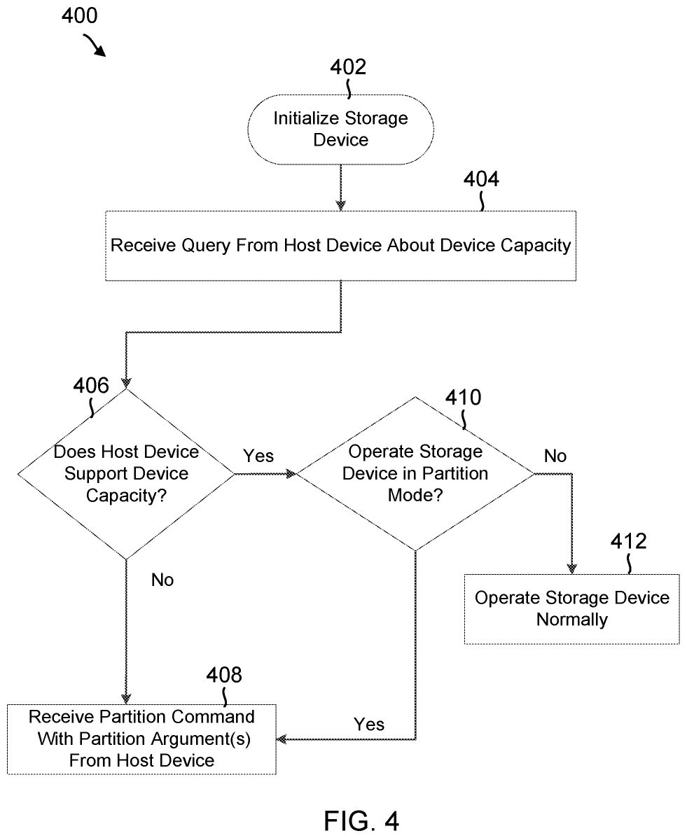

FIG. 4 is a flowchart 400 illustrating an exemplary embodiment of a method for initializing a storage device with multiple partitions in memory. For example, one or more steps of the method can be carried out in a storage device 102 or a host device 104, such as the ones illustrated in FIG. 1. One or more of the steps in the flow chart can be controlled using the controller as described below (e.g. controller 123), the firmware of the host device, or by some other suitable means.

As represented by block 402, the storage device is initialized. For example, once the storage device 102 is connected to the host device 104, the host device and storage device may communicate via the host interface 106 to ready the storage device for normal use. During or after initialization, as represented by block 404, the controller receives a query or request from the host device regarding the storage device capacity of the storage device. For example, the controller may receive a storage device capacity request from the host device for the storage device capacity 128, and the controller may transmit the storage device capacity to the host device.

As represented by block 406, the host device determines whether it supports the storage device capacity. For example, the host device 104 may only support 32 GB memory capacity, while the storage device capacity 128 may indicate the storage device 102 has 512 GB of memory. If the host device 104 determines that its supported capacity is less that the storage device capacity, such as in the aforementioned example, then as represented by block 408, the host device sends to the storage device a partition command with arguments or parameters to divide the NVM 110 into specified partitions. For example, referring to FIG. 3, the controller of the storage device may divide the memory locations 302 of the NVM 110 into multiple partitions 304 in response to the partition command.

However, if the host device 104 determines at block 406 that its supported capacity is greater than or equal to the storage device capacity, then the host device 104 determines at block 410 whether to operate the storage device in a partition mode. For instance, if the host device supporting 32 GB memory capacity initially receives a storage device capacity 128 indicating the storage device 102 has 32 GB or less of memory in total, the host device may nevertheless determine to send a partition command as represented above by block 408. Alternatively, since the host device supports the storage device capacity, the host device may instead decide to operate the storage device normally, as represented by block 412. For instance, the host device may immediately begin to send read, write, or erase commands to the storage device without requesting any partitioning.

Thus, the storage device 102 allows the host device 104 to execute read, write, or erase commands for data in dynamically created partitions of the NVM 110. Initially, the storage device 102 may select one of the partitions for the host device 104 to use for executing host device commands. To keep track of the currently selected partition, the controller 123 of the storage device may set a flag 130 indicating an identifier of the currently selected partition, and the controller 123 may store that identifier in the NVM 110 so that flag persists across power cycles. For example, referring to FIG. 3 where multiple partitions 304 are created, the storage device 102 may select partition (0) initially for the host device to read and write data to the associated memory locations 302, and set and store a flag equal to a value corresponding to the selected partition (e.g. 0 or another number).

Furthermore, the storage device 102 may allow the host device 104 to switch between various partitions in response to a partition switching command received from the host device. For instance, in the example of FIG. 3, the host device may send a partition switching command to the storage device to select a different partition (e.g. partitions (1), (2), or (3)), and the controller 123 may update the flag 130 to a value corresponding to the newly selected partition (e.g. 1, 2, 3, or another number). When the host device subsequently sends read, write, or erase commands to be executed by the storage device, the storage device may route the logical addresses in the host device's commands to the new partition (e.g. as discussed below)

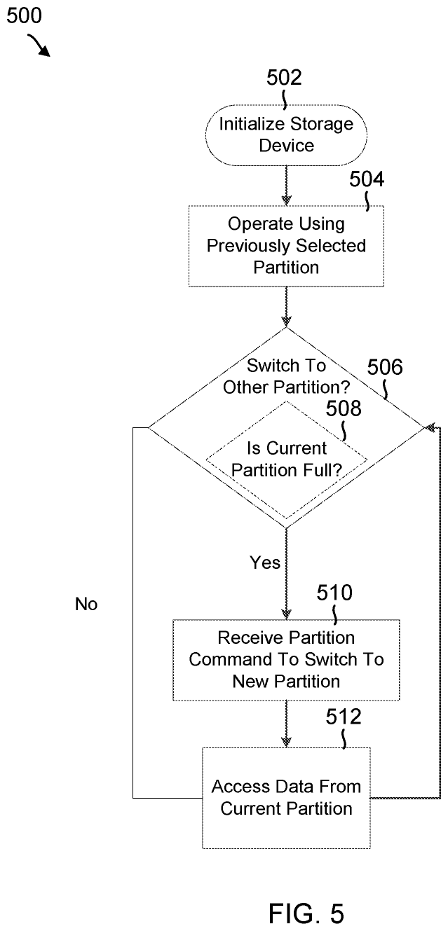

FIG. 5 is a flowchart 500 illustrating an exemplary embodiment of a method for switching between partitions in a storage device. For example, one or more steps of the method can be carried out in a storage device 102 or a host device 104, such as the ones illustrated in FIG. 1. One or more of the steps in the flow chart can be controlled using the controller as described below (e.g. controller 123), the firmware of the host device, or by some other suitable means.

As represented by block 502, the storage device may be initialized. Block 502 may correspond to block 402 of FIG. 4. Block 502 may also include the aforementioned process described with respect to blocks 404-410 of FIG. 4, in which the controller 123 creates partitions in the NVM 110 in response to the partition command from the host device. Afterwards, as represented by block 504, the storage device may operate using a previously selected partition. For example, if block 504 occurs immediately after the partitions are first created, the controller may operate to execute read, write, and erase commands of the host device in a default or initially selected partition. Alternatively, if block 504 occurs after a partition switching command has occurred, the controller may operate to execute commands of the host device in the previously switched partition.

Subsequently, as represented by block 506, the host device may determine whether to switch to another partition. In one example, as represented by block 508, the host device may determine to switch partitions if the currently selected partition is full. For instance, the host device may request information regarding the available memory in the partition from the storage device, and the host device may determine from the available memory reported by the storage device whether the partition is currently full. If the partition is full, the host device may send a partition switching command to the storage device for the controller 123 to execute. In another example, the host device may determine to switch to another partition based on user credentials. For example, referring to FIG. 3, each partition 304 may be associated (and password protected as described below) with a different user, and when a new user logs on to the host device, the host device may send a partition switching command to the partition corresponding to the logged user for the controller 123 to execute. In a further example, the host device may determine to switch to another partition based on cell performance. For example, referring to FIG. 3, each partition 304 may correspond to different levels of cell performance (e.g. one partition may include memory locations with only SLCs and thus be higher performance than another partition which may include memory locations with only QLCs or some other higher level cell). Thus, if the host device determines that it has critical or other important data that needs to be stored requiring higher performance, the host device may determine to switch to the higher performance partition and send a partition switching command to the controller 123 to execute accordingly; otherwise, the host device may determine to switch to a lower performance partition and send the partition switching command to the controller 123 to execute accordingly.

As represented by block 510, if the host device determines to switch to another partition, the controller of the storage device receives a partition switching command identifying the new partition from the host device as described above. The storage device may then update the flag 130 to indicate the new partition, and as represented by block 512, the storage device may allow the host device to access data from the new partition (e.g. by routing the logical addresses received in subsequent read, write, and erase commands as discussed below). Otherwise, the storage device maintains the flag 130 as-is to indicate the previously selected partition, and the storage device allows the host device to continue accessing data from the unchanged partition.

The host device may request partitioning, such as described in the examples of FIGS. 3-4, by sending a command to the storage device with predefined arguments or parameters (e.g. a number and size of the partitions to be created). Similarly, the host device may request to switch between partitions, such as described in the example of FIG. 5, by sending a command to the storage device with different arguments or parameters (e.g. a partition identifier of a newly selected partition). The host device 104 may also request the storage device 102 to perform other actions related to partitioning; for instance, the host device may request the storage device to identify the number of partitions available for the host device, divide available partitions, merge available partitions, and password protect available partitions. These commands may be embodied within a single, vendor-specific command (such as CMD 56) differentiated by specific arguments or parameters, and may be tuned per user request. For example, the controller of the storage device may be preconfigured (e.g. by the vendor of the storage device) or dynamically configured (e.g. by a user of the storage device) to identify and report the number of available partitions, select between available partitions for the host device, and perform other commands (examples of which are described below) in response to different arguments received within the vendor-specific command.

In one example, the vendor-specific command may be a partition dividing command which allows the host device 104 to specify the number of partitions to be created and the storage device 102 to logically partition the NVM 110 into the specified number of partitions. The storage device may be configured to perform such operation in response to receiving a command with a parent partition number, a number of partitions needed, and a size of each partition depending upon the number of partitions. During initialization, the partition dividing command may be the same as the partition command described above, and parent partition number may be defaulted to 0. After the partitions are initially created, the partition dividing command may further divide existing partitions identified by their parent partition number.

For instance, in the case of a 128 GB storage device, the host device may initially send a partition dividing command (e.g. the partition command), indicating the parent partition number as 0 with four partitions of 32 GB each (or another number and/or size). As a result, the controller 123 may divide NVM 110 into four partitions of 32 GB each (such as the partitions 304 described above with respect to FIG. 3). Subsequently, the host device may send another partition dividing command to divide one of the partitions 304 (e.g. the fourth partition (3)) into additional partitions. For example, the host device may indicate the parent partition number as 3 with two partitions of 16 GB each (or another number and/or size). As a result, the controller 123 may divide the 32 GB fourth partition (3) into two additional partitions of 16 GB each.

In another example, the vendor-specific command may be a password set command which allows the host device 104 to create a password to protect data stored in the memory locations corresponding to a specified partition, and which allows the storage device 102 to associate the specified password with the identified partition. The storage device may be configured to perform such operation in response to receiving a command with a partition identifier, a password length, and a password string. The password string may be, for instance, 16 bytes (or another number).

For instance, in the example of FIG. 3, the host device may send a password set command indicating to set a password of length 8, with the string “password”, for the partition number 1 (e.g. the second partition 304). As a result, the controller 123 may store the password in the NVM 110 associated with the memory locations (e.g. the logical addresses) included in the second partition. When the controller 123 subsequently receives a partition dividing command, partition switching command, or other command associated with that partition, including a host device command (e.g. write, erase, etc.) for data associated with a logical address or memory location in that partition, the controller 123 may require authentication by the host device (e.g. requesting the password) before executing the command. Alternatively, when the password is a user credential as described above, the controller 123 may initially acquire the password and subsequently acquire the authentication from the host device at the times the user associated with the partition is logged into the host device.

In another example, the vendor-specific command may be a password reset command which allows the host device 104 to request removal of a password previously set for a specified partition, and which allows the storage device 102 to remove the specified password with the identified partition. The storage device may be configured to perform such operation in response to receiving a command with a partition identifier, a password length, and a password string. In this example, the same arguments may be used for the password set command and the password reset command. Therefore, the controller 123 may distinguish between the two commands by determining whether a password exists for the specified partition identifier. If the controller determines that the received password and partition identifier matches the password associated with that identifier, the controller 123 may delete the password in the NVM 110 associated with the memory locations (e.g. the logical addresses) included in the specified partition.

In a further example, the vendor-specific command may be a password change command which allows the host device 104 to request to change an existing password previously set for a specified partition, and which allows the storage device to change the password associated with the identified partition to the specified new password. The storage device may be configured to perform such operation in response to receiving a command with a partition identifier, an old password length, the old password string, a new password length, and a new password string. If the controller 123 determines that the received old password string and partition identifier matches the current password associated with that identifier, the controller 123 may change the password in the NVM 110 associated with the memory locations (e.g. the logical addresses) included in the specified partition.

In another example, the vendor-specific command may be the partition switching command which allows the host device 104 to request to switch to a specified partition and which allows the storage device to select the identified partition, as described for example with respect to FIG. 5. The storage device may be configured to perform such operation in response to receiving a command with a partition identifier and a password string for the corresponding partition. As a result, the controller 123 may allow the host device 104 to switch between available partitions of the storage device 102.

In a further example, the vendor-specific command may be a partition information command which allows the host device 104 to request information related to an identified partition and which allows the storage device to fetch and report the partition information to the host device. The storage device may be configured to perform such operation in response to receiving a command with a partition identifier. The partition information may include, for example, the total number of partitions available, the currently selected partition number, the size of the partition, a password or user associated with the partition, a performance of the partition (e.g. high, low, etc.), or other information related to the partition(s). The partition information may be generated and stored by the controller 123 of the storage device in the NVM 110 in response to receiving the partition command (or the partition dividing command or a partition merging command discussed immediately below).

In an additional example, the vendor-specific command may be a partition merging command which allows the host device 104 to request to merge two (or more) specified partitions into a single partition, and which allows the storage device 102 to combine the two (or more) identified partitions into one partition. The storage device may be configured to perform such operation in response to receiving a command with a first partition identifier, an optional first password string for the first partition, a second partition identifier, and an optional second password string for the second partition. Additional partition identifiers and optional password strings may be included for merging of three or more partitions. For example, referring to FIG. 3, after the host device sends a partition command to create multiple partitions 304, or a partition dividing command to divide one of the partitions 304 into additional partitions, the host device may send a partition merging command to merge at least two of the partitions 304 or additional partitions. In an example, the host device may indicate a first partition number of 0 (corresponding to one 32 GB partition) and a second partition number of 1 (corresponding to another 32 GB partition), and the controller 123 may accordingly combine the two indicated partitions into a 64 GB partition. The controller 123 may replace the identifier associated with one of the previous partitions (e.g. 0) with the newly merged partition, and the logical addresses associated with the memory locations included in the merged partition may be updated accordingly.

In a further example, the vendor-specific command may be a partition deletion command which allows the host device 104 to request to delete all the partitions of the NVM 110, and which allows the storage device to remove all the partitions of the NVM. The storage device may be configured to perform such operation in response to receiving a command without any arguments. As a result, the controller 123 may remove any associations in the NVM 110 of the partitions with the memory locations and logical addresses. Alternatively, the controller 123 may operate to merge the existing partitions into one single partition (e.g. the entire NVM 110).

While various examples of vendor-specific commands are described above, they are not intended to be limiting; other commands similarly related to partitioning with different arguments may be configured for operation by the storage device. Additionally, the vendor-specific commands described above may be performed based on separate individual commands or groups of commands, rather than a single command with different arguments. For instance, the password set command, the password reset command, and the password change command may all be comprised in a single partition password command with different arguments. Furthermore, it should be noted that the passwords mentioned in the examples above may be different than a Card Lock Password (CLP) or a Card Ownership Password (COP) which operate to completely lock or protect the entire NVM 110. In contrast, the passwords described above refer to partition passwords which are associated with and protect certain logical addresses (e.g. the LBAs associated with the memory locations included in the partition), and which prevent the data from being read, written, or erased from those memory locations without successful password authentication by the controller 123 of the storage device.

As indicated above, the storage device divides the logical addresses associated with the memory locations of each partition. For example, 25% of the logical addresses of NVM 110 may be associated with the first partition, 25% of the logical addresses may be associated with the second partition, etc. The storage device may determine the division of logical addresses based on the partition sizes, and store this division information in the NVM 110. When the host device subsequently sends read, write, or erase commands with logical addresses to the storage device after initially selecting or switching to a partition, the storage device may route the command to the associated logical address of the selected partition by updating the logical address according to the division information. The storage device may also update the logical address based on the flag 130 stored in the NVM 110, which the storage device updates to identify the current partition number, and based on the maximum logical address associated with the partition size.

For example, referring to FIG. 3, the storage device 102 may receive a partition command from the host device 104 to partition the NVM 110 into four partitions 304. Assuming each partition includes memory locations associated with one million logical addresses, the storage device 102 may divide the first partition (0) to include LBAs 0-999999, the second partition (1) to include LBAs 1000000-1999999, etc., and store this division information in the NVM 110. When the storage device 102 receives a host device command to read data associated with LBA 0, for example, the storage device 102 identifies the current partition based on the flag 130. For instance, if the first partition (0) is selected, the flag 130 may store the value 0, and the storage device may determine the first partition (0) to be the current active partition. As a result, the storage device may simply execute the command for LBA 0 as requested. However, if the second partition (1) is selected, the flag 130 may store the value 1, and the storage device may determine that the second partition (1) is the current active partition. As a result, the storage device may route the command to the correct LBA by updating the LBA to 1000000 (which corresponds to LBA 0 of the second partition). The storage device may similarly route commands to LBAs based on the selected partition.

In one example, the updated LBA may be calculated as described above by adding the initial starting address (LBA 0) to the maximum logical address for each prior partition size to the logical address in the command. For instance, in the example described above where the second partition is selected and the maximum logical address for the first partition size is 1000000, a host device command for LBA 100 would result in the updated LBA of 0+1000000+100=1000100. Similarly, if the third partition is selected and the maximum logical address for the first and second partition sizes are each 1000000, a host device command for LBA 100 would result in the updated LBA of 0+1000000+1000000+100=2000100. The above examples assume the partitions are divided equally. If the partitions are unequal (e.g. the maximum logical addresses would be different for separate partitions), the updated LBA would be calculated accordingly.

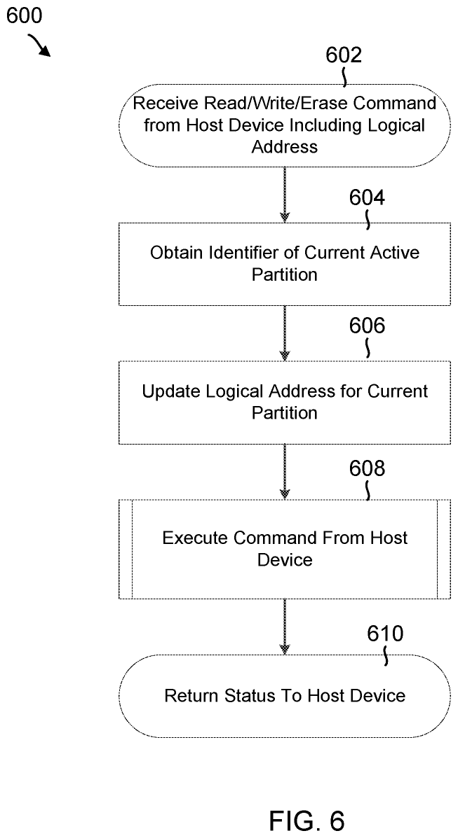

FIG. 6 is a flowchart 600 illustrating an exemplary embodiment of a method for executing a command from a host device in a partition of the storage device. For example, the method can be carried out in a storage device 102 such as the one illustrated in FIG. 1. Each of the steps in the flow chart can be controlled using the controller as described below (e.g. controller 123), or by some other suitable means.

As represented by block 602, the controller receives a host device command (e.g. a read, write, or erase command) from the host device including a logical address. For instance, as described above, the controller 123 may receive a read command from the host device for data associated with LBA 100.

As represented by block 604, the controller obtains an identifier of the current active partition for the host device. For example, the controller 123 may obtain the flag 130 from the NVM and identify the value to be 1, corresponding to the second partition 304.

As represented by block 606, the controller updates the logical address included in the host device command for the current partition. For instance, as described above, the controller 123 may update the LBA by adding the initial starting address (LBA 0) to the maximum logical address for the prior partition size(s) to the logical address in the command. For instance, in the example described above where the second partition is selected and the maximum logical address for the first partition size is 1000000, the controller may determine the updated LBA to be 1000100.

As represented by block 608, the controller executes the command received from the host device. For example, the controller 123 may activate the sense amplifiers 124 to read the data 119 associated with LBA 1000100 based on the host device command and the updated logical address for the current partition.

Lastly, as represented by block 610, the controller returns the status of the command execution to the host device. For instance, the controller 123 may report the data 119 to the host device with an indication that the read command was successful.

Accordingly, the present disclosure adapts to the supported capacity of the host device by allowing for partitioning of memory to the host device's needs, without requiring host device firmware upgrades or replacements to support larger storage capacities. Moreover, by allowing the host device to switch between different partitions, the storage device allows the host device to virtually access the maximum storage provided by the storage device. Furthermore, by providing the ability to create password-protected partitions associated with different user credentials, the present disclosure minimizes data loss by preventing comingling or overwriting of different users' data. The present disclosure also may allow users to access their respective partitions when they log in to the host device using their associated user credentials. Additionally, the present disclosure may virtually provide a higher endurance storage device, for example, by configuring a partition with lower level cells having higher performance for a host device to access, and may allow users to store different types of data (e.g. important and less important data) in different partitions based on desired levels of performance.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) in the United States, or an analogous statute or rule of law in another jurisdiction, unless the element is expressly recited using the phrase “means for” or, in the case of a method claim, the element is recited using the phrase “step for.”

What is claimed is:

1. A storage device, comprising:
memory configured to store data; and
a controller configured to partition the memory into multiple partitions for a host device based on a partition command received from the host device;
wherein the controller is further configured to switch from a first one of the partitions to a second one of the partitions in response to a partition switching command received from the host device,
wherein the controller is further configured to execute a command received from the host device on data associated with the second one of the partitions.

2. The storage device of claim 1, wherein the partition command is based on a maximum storage capacity or a selected storage capacity for the host device.

3. The storage device of claim 1, wherein the controller is further configured to allow the host device to access the second one of the partitions while preventing access to other ones of the partitions by the host device.

4. The storage device of claim 1, wherein the partition command is based on a supported capacity of the host device.

5. The storage device of claim 1, wherein the controller is further configured to store a storage device capacity in the memory and to provide the storage device capacity to the host device in response to a storage device capacity request from the host device.

6. The storage device of claim 5, wherein the controller is further configured to update the storage device capacity in the memory based on the partition command and to provide the updated storage device capacity to the host device.

7. A storage device, comprising:
memory configured to store data; and
a controller configured to partition the memory into multiple partitions based on a partition command received from a host device, the controller being further configured to receive a command from the host device associated with data including a logical address, to update the logical address based on a selected one of the partitions for the host device, and to execute the command on data associated with the selected one of the partitions based on the updated logical address.

8. The storage device of claim 7, wherein the memory is configured to store a flag indicating the selected one of the partitions, and wherein the controller is further configured to update the logical address based on the flag.

9. The storage device of claim 8, wherein the controller is further configured to update the flag based on a partition switching command received from the host device.

10. The storage device of claim 7, wherein the controller is further configured to divide one of the partitions into additional partitions based on a partition dividing command received from the host device.

11. The storage device of claim 7, wherein the controller is further configured to merge at least two of the partitions based on a partition merging command received from the host device.

12. The storage device of claim 7, wherein the controller is further configured to at least one of set, reset, or change a password associated with the selected one of the partitions based on a partition password command received from the host device.

13. The storage device of claim 7, wherein the controller is further configured to provide partition information to the host device in response to a partition information command received from the host device.

14. The storage device of claim 7, wherein the controller is further configured to remove the partitions based on a partition deletion command received from the host device.

15. The storage device of claim 7, wherein the memory comprises cells, and the memory is partitioned based on a performance of the cells.

16. A storage device, comprising:
memory configured to store data; and
a controller configured to partition the memory into multiple partitions for a host device based on a partition command received from the host device, the controller being further configured to select one of the partitions based on user credentials received from the host device;
wherein the controller is further configured to execute a command received from the host device on data associated with the selected one of the partitions.

17. The storage device of claim 16, wherein the controller is further configured to set a password associated with the selected one of the partitions based on a password set command received from the host device.

18. The storage device of claim 17, wherein the controller is further configured to reset the password associated with the selected one of the partitions based on a password reset command received from the host device.

19. The storage device of claim 17, wherein the controller is further configured to change the password associated with the selected one of the partitions based on a password change command received from the host device.

20. The storage device of claim 17, wherein the password associated with the selected one of the partitions is different than a card lock password (CLP) or a card ownership password (COP) associated with the storage device.
